(19) United States
(12) Patent Application Publication
(10) Pub. No.: US 2003/0208901 A1
(43) Pub. Date: Nov. 13, 2003

(54) Design optimization of planar type write heads for ultra high density magnetic recording

(76) Inventors: Sang Ho Lim, Seoul (KR); Hi Jung Kim, Seoul (KR); Kyoung Suk Kim, Kyunggi-do (KR)

Correspondence Address: HARNESS, DICKEY & PIERCE, P.L.C., P.O. BOX 828, BLOOMFIELD HILLS, MI, 48303, US

(21) Appl. No.: 10/241,910

(22) Filed: Sep. 12, 2002

(30) Foreign Application Priority Data
May 8, 2002 (KR) 2002-25317

(51) Int. Cl. G11B 5/127; H04R 31/00

(52) U.S. Cl. 29/603.12; 29/603.09

(57) ABSTRACT

The present invention relates to the method of optimizing of planar type write heads for ultra high density magnetic recording. More particularly, the invention relates to a planar type write head for an ultra high density drive which can record information on a medium with high magneto-crystalline anisotropy.

One of the most serious problems for high density recording is thermal fluctuation and this problem can be solved by using a medium with high magneto-crystalline anisotropy. However, this requires a write head capable of generating a high write field

According to the present invention, the method of optimizing a planar type write head for ultra high density magnetic recording comprises the step of optimizing the characteristics of the write head by changing the shape parameters of the write head using the first, second a0nd third type shape control methods.

### BACKGROUND OF THE INVENTION

The present invention relates to the method of optimizing of planar type write heads for ultra high density magnetic recording. More particularly, the invention relates to a planar type write head for an ultra high density drive which is capable of recording information on a medium with high magneto-crystalline anisotropy.

The magnetic recording technology has been continuously developing for several decades. As a specific example, the rate of recording density has been increasing annually at 60 percent. More recently, the development speed has been much accelerated so as to reach 100% for the annual increase in recording density. This implies a two fold increase in recording density for each year. This remarkable technological achievement has been rendered possible mostly through utilizing a progressive technology known as scaling. The essence of the scaling technology is reducing the size of whole devices into a fixed ratio. It is expected that the current trend in the technological development will continue for several more years, however, the magnetic recording technology will hit a theoretical limit at a certain stage.

The main reason for this theoretical limit is thermal fluctuation. More specifically, this phenomenon involves erasing of magnetically recorded information by heat energy

[P. L. Lu and S. H. Charap, IEEE Transactions on Magnetics, 31 (1995) 2767; R. L. White, Journal of Magnetism and Magnetic Materials, 209 (2000) 1-5] In order to achieve high recording density, it is necessary to reduce the transition length between two bits. This is normally achieved by reducing the thickness and crystal grain size of a medium.

[B. K. Middleton, Journal of Magnetism and Magnetic Materials, 193 (1999) 24-28; M. Futamoto, N. Inaba, Y. Hirayama, K. Ito and Y. Honda, Journal of Magnetism and Magnetic Materials, 193 (1999), 36-43] When the thickness of a medium decreases, the strength of detection signal becomes weaker. This problem can be solved by using a very sensitive giant magetoresistance read head. However, if the thickness and crystal grain size of a medium is reduced, the volume of each grain is reduced accordingly. Consequently, the reduction is such that magnetic energy is being affected by heat. This phenomenon is called super-paramagnetism. This is a fundamental problem in the area of magnetic recording.

This fundamental problem concerning the thermal fluctuation in the longitudinal magnetic recording cannot be resolved by resorting to the progressive methods such as scaling.

To date, many revolutionary ideas have been proposed. One of them is using a medium with high magneto-crystalline anisotropy. Here, the transition length is reduced with respect to increase in the magneto-crystalline anisotropy energy and the thermal stability of the medium is enhanced.

However, due to its large coercive force, it is nearly impossible to write on the medium with high magneto-crystalline anisotropy energy with a conventional write head.

The magnetic field generated by the conventionally used write heads is too small (6000-8000 Oe) to record on a medium with high magneto-crystalline anisotropy.

### SUMMARY OF THE INVENTION

Various types of write heads have been proposed in order to overcome the above mentioned problems. One of them is a planar type write head. The planar type write head is capable of generating high recording magnetic field due to the shape of its head although a conventional magnetic material is used.

In spite of the above advantages, the other characteristics of the conventional planar type write heads which are required for high density magnetic recording such as the side writing ratio and recording magnetic field distribution are not excellent. Hence, these characteristics should be improved through the optimization of the head.

The most serious single problem for achieving ultra high density magnetic recording is thermal fluctuation. Using a medium with high magneto-crystalline anisotropy is one of the solutions to the problem. However, in order to record information on a medium with high magneto-crystalline anisotropy requires high recording magnetic field.

Accordingly, the object of the present invention is to provide a method of optimizing the design of a write head in order to achieve ultra high density magnetic recording using a medium with high magneto-crystalline anisotropy.

According to the present invention, the method of optimizing the design of a planar type write head for achieving ultra high density magnetic recording using a medium with high magneto-crystalline anisotropy comprises the step of optimizing the characteristics of the write head by changing the shape parameters of the write head using the first, second and third type shape control methods that take certain parts of the write head as the shape and size of a, b, and c.

### BRIEF DESCRIPTION OF THE DRAWINGS

FIG. 1 shows the conventional shape of a planar type head with no head shape control.

FIG. 2 is a graph which shows the variation of three components of recording magnetic field with respect to the bit direction.

FIG. 3 is a graph which shows the variation of three components of recording magnetic field with respect to the track width direction.

FIG. 4 shows the method of optimizing the planar type head according to the present invention.

FIG. 5 shows the relationship between the maximum magnetic field and half width for the head with or without the head shape control.

FIG. 6 shows the relationship between the maximum magnetic field and side writing ratio for the head with or without the head shape control.

FIG. 7 shows the recording pattern obtained from the present invention with no head shape control.

FIG. 8 shows the recording pattern obtained from the present invention with an optimal head shape control.

### DETAILED DESCRIPTION OF THE EMBODIMENTS

Hereinafter, preferred embodiments of the present invention will be described in detail with reference to the accompanying drawings.

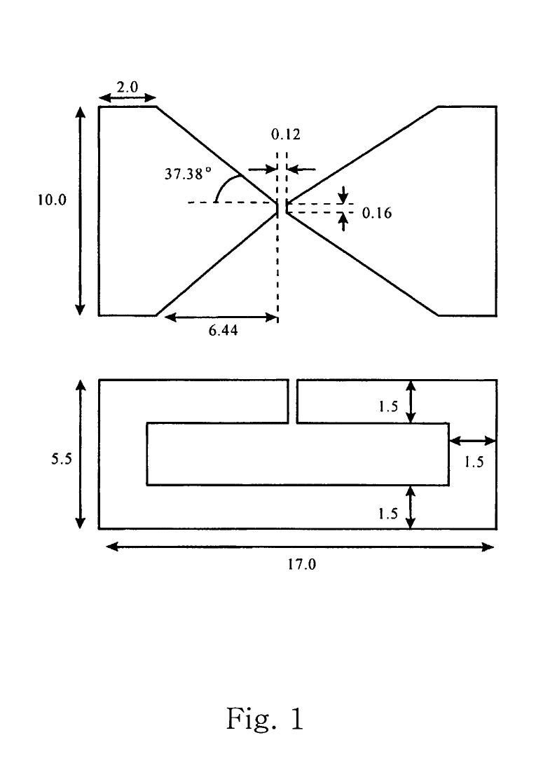

FIG. 1 shows the conventional shape of a planar type head. The actual size of the head in FIG. 1 is not shown on the diagram in order to show the shape of the head more accurately. The diagram at the top is the shape of the head viewed from the medium (air bearing surface (ABS)) and the diagram at the bottom is a side view of the head. The numbers representing the size are all in μm. Some of the important parameters include a gap length 0.12 μm, track width 0.16 μm, relative permeability of magnetic material 500, saturation flux density 1.9 Tesla(T), magnetic electromotive force 0.4 A.Turn.

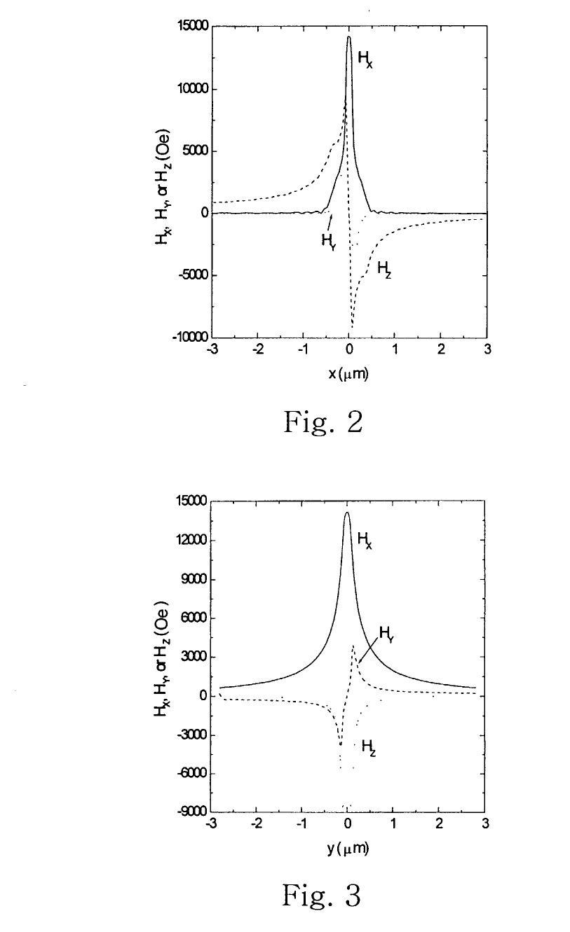

Also, the shape and magnitude of the recording magnetic field obtained from the head as shown in FIG. 1 are represented in FIG. 2 and FIG. 3. FIG. 2 shows the variation of three components of recording magnetic field with respect to the bit direction wherein the three components include a magnetic field component (Hx) for the longitudinal bit direction, a magnetic field component (Hy) for the track width direction and a magnetic field component (Hz) which is perpendicular to the medium.

Except the result for the Hy component, the original point of the horizontal axis is located at 17.5 nm away from the center of the head gap and width. For the result of the Hy component, the original point of the vertical axis is located at a half the length of the track width (0.08 μm) away from the center of the head gap and width. More specifically, the result of the Hy component is obtained along the corner sections of the track.

FIG. 3 shows the variation of the three components of recording magnetic field, namely, Hx, Hy and Hz with respect to the track width direction. In FIG. 3, the original point of the horizontal axis is located at 17.5 nm away from the center of the head gap and width. The most important fact in magnetic recording is the field shape variation of the Hx component along the x direction.

The maximum value of Hx from a planar type head with no head shape control is 14183 Oe which is quite large. However, it is disadvantageous since the side writing ratio for the same head is too large and recording magnetic field distribution is too wide.

This is the problem which should be overcome in order to achieve ultra high density magnetic recording. As a result, the design of the head is optimized.

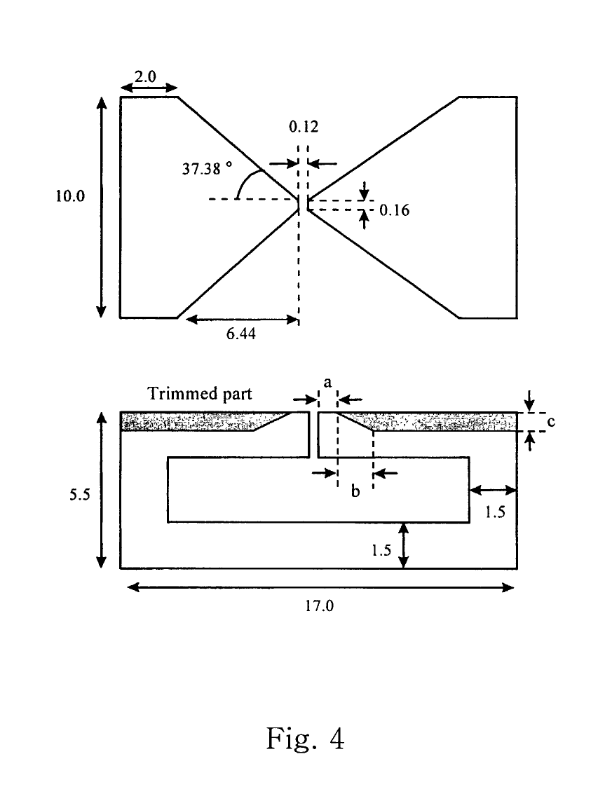

FIG. 4 shows the method of optimizing a planar type head according to the present invention. The diagram at the top is the shape of the head viewed from the medium (air bearing surface (ABS)) and the diagram at the bottom is a side view of the head. The optimization of the head is achieved by trimming some parts of the head (head trimming). The shaded area in FIG. 4 is trimmed area and the shape and size of the trimmed area are represented as a, b, and c.

Three different methods of controlling the head shape are used, namely, the first, second and third type methods and the head shape control methods are explained in detail in Table 1.

In the first type method, b is assigned as 0 μm and c is 0.2 μm and a is between 0.12 μm and 0.3 μm. Since b is fixed as 0, the shape of the trimmed part in the first type method is a step-like. In the second type method, this step-like shape is declined as b is varied between 0.2 μm and 0.6 μm.

In the second type method, a is 0.12 μm and c is 0.2 μm. In the second type method, if b becomes smaller, the characteristic of the head becomes similar to the first type method. The third type method is similar to the first type method since b and c are fixed and only a varies. However, in this case, b is not 0 but is assigned as 0.4 μm and c is 0.4 μm.

There are many number of parameters which can represent the characteristics of a head. But for the present invention, only three parameters are used, namely, the maximum magnetic field (Hmax), half width d50 of magnetic field distribution, side writing ratio (Rsw).

These three types of parameters can define the three components of magnetic field, Hx, Hy and Hz. In the present invention, only three parameters concerning Hx which most affects magnetic recording are considered.

d50 is defined as the width of magnetic field distribution at 50% of the maximum magnetic field. Rsw is defined as Htw/Hg and in this instance, Htw is the magnetic field at the point which is separated (1.1×track width (0.176 μm)) from the center of the gap along the track width direction and Hg is the magnetic field at the gap center.

Similar to FIGS. 2 and 3 which show the results for no head shape control, all of the results are obtained from a point which is separated from 17.5 nm from the center of the head.

Among the three head parameters mentioned above, the performance of the head becomes superior as the value of Hmax increases whereas the values of d50 and Rsw decrease.

In order to optimize the performance of the head, the relationship among the three parameters is investigated.

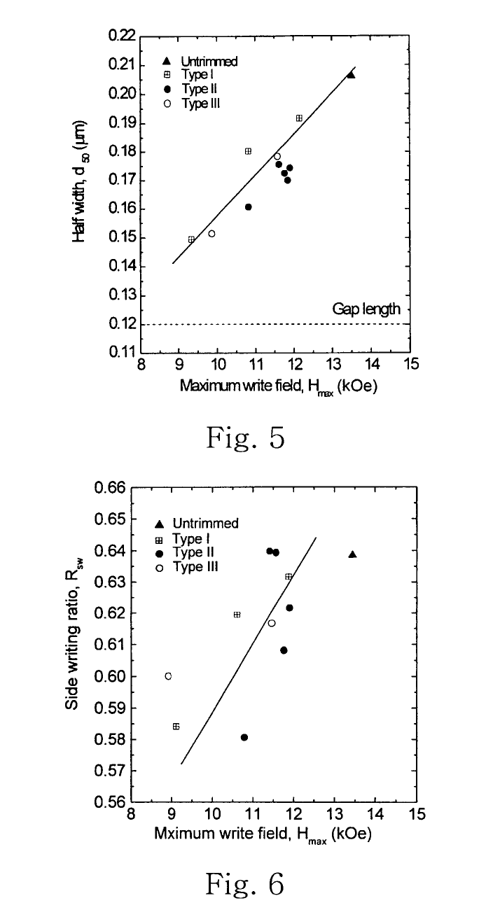

FIG. 5 shows the relationship between d50 and Hmax. As shown in FIG. 5, the relationship between d50 and Hmax is positive, more specifically, the magnitude of d50 increases with the corresponding increases in Hmax. As can be expected, the magnitude of Hmax decreases with the head shape control. At the same time, the magnitude of d50 also decreases with the head shape control. The relationship between these two types of parameters is largely dependent upon the type of head shape control.

In case of the first type shape control method which is represented as a square in FIG. 5, the magnitude of d50 is located above the mean correlation line (shown as a full line in FIG. 5) whereas in case of the second type shape control method which is represented as a shaded circle, the magnitude of d50 is located below the mean correlation line. These results show that the magnitude of d50 is bigger in the first type in comparison to the second type for the same value of Hmax.

It is presumed that the bigger value of d50 is related to the step-like head shape after the head shape control. In the third head shape control, d50 is located between the first and second type. Another important characteristic in the relationship between d50 and Hmax as shown in FIG. 5, is the values of d50 and Hamx are not sensitive in the second type head shape control but they become sensitive in the first and second type head shape control.

The magnitude of d50 obtained from the present invention is bigger than the gap length (0.12 μm). As an example, the magnitude of d50 is 1.7 time bigger than the gap length for the head without any head shape control.

FIG. 5 shows the relationship between Rsw and Hmax. Unlike the relationship between d50 and Hmax, the correlation between Rsw and Hmax is not very good. However, similar to the relationship between d50 and Hmax, the correlation coefficient is also positive. More specifically, Rsw tends to increase with the increase in Hmax.

In the perspective of design optimization, the relationship between Rsw and Hmax, which is not very positive, is preferable since it is easy to identify a head with superior characteristics. Unlike the relationship between d50 and Hmax in FIG. 5, the characteristics of the head are very much dependent on the head shape control. However, one noticeable feature is that the magnitude of Rsw varies greatly whereas the range of Hmax is very narrow in the case of the second type head.

For the second type, small Rsw values are obtained at b=0.2 and 0.5 μm (the smallest value is obtained at b=0.2 μm) and large Rsw values are obtained when b=0.3 μm and 0.4 μm.

From FIGS. 5 and 6, it is presumed that the optimized head should have the smallest Rsw value. However, the optimized head was obtained from the second type head when a=0.12 μm, b=c=0.2 μm. At this instance, the small value of Hmax=10.8 kOe cancels out the main advantages of the planar type head. As a result, the optimized head is obtained in the second type head when a=0.12 μm, b=0.5 μm and c=0.2 μm. For this head, the value of Rsw is second smallest.

In order to test the performance of the optimized head, record pattern was formed using a micro magnetic computer simulation. These results are compared with the record pattern which was obtained from a head without the head shape control.

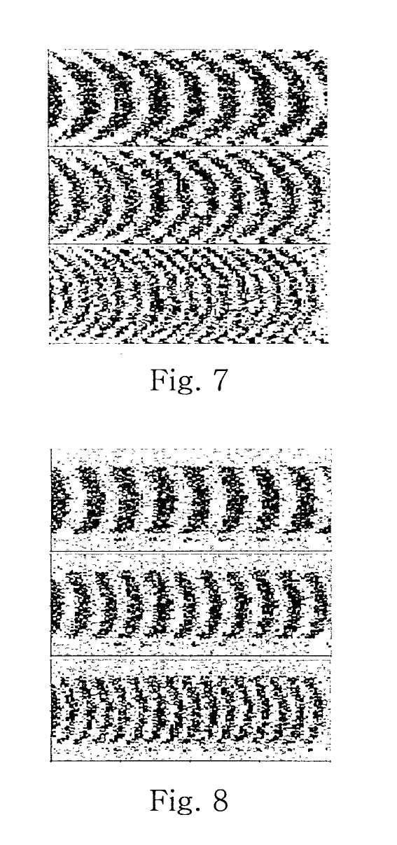

FIG. 7 shows the recording pattern obtained from the present invention with no head shape control. FIG. 8 shows the recording pattern obtained from the present condition with an optimal head shape control.

The results were represented at three different type of bit densities, namely, 454 kfci (kilo flux change per inch) (shown at the top), 605 kfci (shown at the middle) and 907 kfci (shown at the bottom).

In order to make the recording conditions similar to each other, it is assigned that the ratio obtained by dividing the magnitude of the constant for magneto-crystalline anisotropy of the medium by Hmax to be the same.

Since the Hmax value for the optimized head is smaller than the Hmax value for the head with no head shape control, the value of the constant for magneto-crystalline anisotropy for the optimized head is smaller than the value of the constant for magneto-crystalline anisotropy for the head with no head shape control.

More specifically, the value of the constant for magneto-crystalline anisotropy of the optimized medium is 3.5×10E5 J/m3 and the value of the constant for magneto-crystalline anisotropy of the medium with no head shape control is 4.0×10E5 J/m3.

As shown in FIGS. 7 and 8, the recorded pattern has improved significantly when the optimized head was used. For the case of the head with no head shape control the shape of the bit is either curved or the width of the recorded pattern is much longer than the track width of the actual write head. These problems have been largely eradicated by utilizing the optimized head. More specifically, the shape of the bits is much less curved and the track width has been significantly reduced.

As an example, in case of utilizing a head with no head shape control, the track width value at 605 kfci bit density is 390 nm whereas when an optimized head was used this value becomes 220 nm. This implies that the track density can greatly be increased by the optimization of the head.

One more noticeable feature is that in case when no head shape control is used, the record pattern at 907 kfci bit density is very unclear however, the record pattern at the same point with the head shape control is very clear.

As explain so far, the planar type write head for an ultra high density drive according to the present invention can record information on a medium with high magneto-crystalline anisotropy. The use of a medium with high magneto-crystalline anisotropy overcomes the thermal fluctuation problem even at the ultra high density magnetic recording. Especially, the values of d50 and Rsw are reduced through the optimization of head using the head shape control in order to attain a higher recording density than the planar type head with no head shape control.

The following is a detailed explanation through examples of the invention. It should be understood, however, that the detailed description and specific examples are given by way of illustration only, since various changes and modifications within the spirit and scope of the invention will become apparent to those skilled in the art from this detailed description.

What is claimed is:

1. A method of optimizing the design of a planar type write head for achieving ultra high density magnetic recording using a medium with high magneto-crystalline anisotropy, wherein the design of said write head are optimized by changing the shape parameters of said write head using the first, second and third type shape control methods that take certain parts of said write head as the shape and size of a, b, and c.

2. The method as claimed in claim 1, wherein said the first type method fixes each value of a and c as a certain value and only varies the value of b in order to have a step-like shape for the trimmed part.

3. The method as claimed in claim 1 or claim 2, wherein said the second type method fixes each value of a and c as a certain value and when the value of b is reduced in order to have a head design which is similar to the shape in the first type method.

4. The method as claimed in claim 1, wherein said the second type method fixes each value of a and c as a certain value and when the value of b is reduced in order to have a head design which is similar to the shape in the first type method.

5. The method as claimed in claim 2, wherein said third type method fixes each value of b and c as a certain value and only varies the value of a in order to have a head design which is similar to the shape in the first type method.

6. The method as claimed in claim 1, wherein said the design of said write head is optimized by utilizing the the maximum magnetic field (Hmax), half width d50 of magnetic field distribution, and side writing ratio (Rsw).

7. The method as claimed in claim 4, wherein said the design of said write head is optimized by utilizing the the maximum magnetic field (Hmax), half width d50 of magnetic field distribution, and side writing ratio (Rsw).

8. The method as claimed in claim 1, wherein the value of the constant for magneto-crystalline anisotropy of said optimized medium is very large in the range of 3.5×10E5 J/m3.
